(19) United States
(12) Patent Application Publication
(10) Pub. No.: US 2012/0260911 A1
(43) Pub. Date: Oct. 18, 2012

(54) HIGHLY HYDRATED STARCH AND PROCESS FOR ITS PRODUCTION

(76) Inventor: Michelle Gothard, Royston, Hertfordshire (GB)

(21) Appl. No.: 13/514,272

(22) PCT Filed: Dec. 24, 2010
(86) PCT No.: PCT/GB2010/052213

§ 371 Date: Jun. 26, 2012

(30) Foreign Application Priority Data
Dec. 24, 2009 (GB) 0922547.5

(51) Int. Cl. C08B 30/12

(52) U.S. Cl. 127/32; 127/71

(57) ABSTRACT

A process of producing a highly hydrated hyper-swollen gelatinised starch is described and comprises: combining a starch-containing product with a working fluid (e.g. water) to form a mixture; inducing the mixture to flow through an inlet into a passage; and injecting a high velocity (e.g. supersonic) transport fluid into the mixture through a nozzle communicating with the passage; wherein the injection of the high velocity transport fluid: applies a shear force to the mixture such that the mixture is atomised and forms a vapour and droplet flow regime; forms an at least partial vacuum within the passage downstream of the nozzle; and generates a condensation shock wave within the passage downstream of the nozzle and vacuum by condensation of the transport fluid to produce a hyper-swollen hydrated gelatinised starch. Hyper-swollen hydrated gelatinised starches, polysaccharides and polyolefins made by the process of the present invention are also provided and have broad utility, for example in food, medical, paper, cosmetic, textile and construction industries.

The present invention relates to a gelatinised starch, and in particular to a high viscosity, highly hydrated starch with high volume occupancy, and to a process for making such a starch. Such starches provide, e.g., increased enzymatic access to glucosidic linkages and improved digestibility. Moreover, such starches also provide additional benefits in, e.g., the manufacture of shaped products such as cereal food, companion animal feed, and aquatic animal feed.

Starch is a biopolymer which occurs naturally as a plant storage product, for example in tubers, roots and grains or seeds. In its native state in vivo, starch occurs as a semi-crystalline granule or grain, held in granular storage bodies of plants. Starches from different botanical sources tend to be different shapes, and are often of very different sizes, for example potato starch granules tend to be large, with a diameter in the range of 60 to 100 microns though it can vary from 15 to 100 microns. Rice starch granules tend to be of the order of 3 to 8 microns in size. Starch predominantly comprises two types of polysaccharide: amylose and amylopectin. Amylose is a linear molecule comprising (1-4) α-D-glucopyranosyl units, with occasional branching via α(1-6) linkages. Amylopectin contains α-D-glucopyranosyl units, linked mainly by α(1-4) linkages and with a significant proportion of α(1-6) linkages to give a highly branched structure. In a starch grain, the amylopectin polymers are arranged outwardly from a central point, the hilum. The hilum can appear in the centre of the grain with uniform polymer layers extending from it as in maize starch, or could be located to one side of the grain with uneven layers of polymers as in potato starch. In some cases more than one hilum can be present, as in rice starch. The amylopectin extending outwardly from the hilum is ordered so that linear sections align in parallel and form hydrogen bonds between the chains. In X-ray diffraction and microscopy studies this alignment appears as concentric bands within the grains. Interspersed between these highly ordered regions are domains of branched amylopectin. Additionally, the predominantly linear amylose chains are also present in varying proportions, dependant upon the botanical source of the starch. Different types of starches contain different proportions of amylose and amylopectin. Some starches, known as waxy starches, are predominantly or completely formed from amylopectin with little or no amylose present. The most commonly used type of waxy starch is waxy maize starch, though other types of waxy starch exist.

Starch is widely used in many different industries, most notably, e.g., as a thickener in food and beverages, but is also important in paper-making, cosmetics, in the textile industry for instance as a size and in dyes, in animal foodstocks, as an additive in various products used in the construction industry such as cement or gypsum wall board, in the oil industry in, for example, drilling muds and to seal walls of bore holes. Starch is also used to make products such as modified sugars, organic acids, syrups, and a wide variety of other chemicals, coatings and surface treatments, composite materials, materials used for consumer products such as electronics, biofuels, pharmaceuticals, bioplastics, adhesives and glues, in packaging, in detergents and soaps, and in rubber and foam making industries. Starch also finds application, for example, in thickeners, stiffening agents, binders, coatings, adhesives, stabilizers, emulsion stabilizers, excipients, fillers, suspension agents, and co-polymers.

For many industrial uses, a naturally occurring starch is treated to modify its chemical structure, thereby altering its physical characteristics to those required. Such treatment can include enzyme treatment (for example with β-amylase to hydrolyse cross-links), although enzymatic treatment is expensive and can be difficult to control. Alternative treatments include chemical modification of the starch by introducing substituent groups, or by combination of the starch with a co-polymer. An example is cationic starch, where the starch has been treated with a reactive compound in order to introduce a positive charge. Cationic starch is widely used in the paper-making industry as the charge gives the starch an affinity for the cellulose fibres. As another example, U.S. Pat. No. 4,552,940 discloses a grafted starch polymer having vinyl polymeric segments due to the use of styrene. Such a grafted starch polymer is disclosed to have excellent decreased viscosity (as low as 1070 cp), but would not be acceptable for food and beverage applications. Moreover use of such chemically modified starches is regulated, for example by the US Food and Drug Administration. Other approaches have focused on identification of particular natural sources of starch. For example, U.S. Pat. No. 5,954,883 discloses that starch from maize which is heterozygous for the sugary-2 allele is particularly useful for chilled food applications due to its stability at low temperatures. As another example, some starches are believed to be cationic or anionic in their naturally occurring state and these are sought for use in some applications. Another approach is selectively breeding, or genetically modifying natural sources to alter/increase or otherwise affect the desired properties and reduce or eliminate undesirable properties.

One of the most common forms of starch processing is the gelatinisation or “activation” of the starch grains; usually by heating in the presence of water. This process breaks hydrogen bonds between the polysaccharides and causes the starch grains to swell, as water solvates the amylose and amylopectin. Gelatinisation is an irreversible process. After gelatinsation a degree of retrogradation can occur. Retrogradation is when free amylase chains released from the main starch grain on gelatinisation can reassociate to form a cross-linked structure or gel.

In undergoing this gelatinisation process each starch grain swells to greatly increase its volume occupancy. In some circumstances the size increase can be by an order of magnitude. From the literature (see, for example, Bhavesh & Koshik ‘Effects of Heating Rate on Starch Granule Morphology and Size (Carbohydrate Polymers, Vol. 65, 3, ″006), Debet & Gidley ‘Three Classes of Starch Granule Swelling’ (Carbohydrate Polymers, Vol. 64, 3, 2006), Tester & Sommerville ‘Swelling and Enzymatic Hydrolysis of Starch in Low Water Systems’ (Journal of Cereal Science, 33, 2000), Jeng-Yuene Li et al ‘Relationship between thermal, rheological characteristics and swelling power for various starches (Journal of Food Engineering, Vol. 50, 3, 2001) and Tim Baks ‘Process Development and Enzymic Hydrolysis of Starch at High Concentrations’ (PhD Thesis, Wageningen University, 2007)), it is known that the degree to which starch grains swell during gelatinisation is governed by factors such as heating rate and type, or pressure, amylose content and the presence of non-starch components such as lipids and proteins, solvated ions, co-solutes and water availability. The degree to which the starch grains swell during gelatinisation influences the physicochemical properties of the gelatinised starch and affects its utility in end products containing the gelatinised starch, for example the gels, films, dispersions, and suspensions in products as discussed above. These physicochemical properties include, but are not limited to, rheological behaviour, stability, retrogradation, and susceptibility to enzymatic hydrolysis and modification. These properties ultimately impact on final process and product qualities and performance.

The hyper-swollen starch of the present invention would have utility, for example, in viscosifying foods providing an improved mouthfeel, by reducing the stickiness and coating normally experienced. Additionally flavour release in-mouth would be enhanced through use of the hyper-swollen starch of the invention, since alpha-amylase accessibility to the starch is improved so that, as the product looses structure and viscosity, the flavour/aroma compounds are refreshed to the tongue and nasal cavity at a faster and/or different rate. In biomedical applications modified, particularly cross-linked starches are used as drug release substrates. The lower density structure of the hyper-swollen starch of the present invention is advantageous over conventional starch materials as the low density structure of the hyper-swollen starch of the invention will allow chemicals and enzymes to penetrate deeper into the material to cross-link and allow a higher degree of cross-linking. The degree and type of cross-linking in combination with other chemical modifications gives control of the rate and type of active substance delivery. In the production of starch-based films for packaging and coatings, dewatering (drying) of the films is a problem because many conventional processes for their manufacture require high concentrations of starch to have the correct viscosities, but even and rapid dehydration is difficult to achieve with the high density of amylopectin macropolymer. Use of the hyper-swollen starch of the invention, provides the required viscosity at much lower starch concentration. The reduced polymer density enhances drying (water diffusion) rates. In general any applications where processing requires an open, low density structure will benefit by using the hyper-swollen starch of the invention,

As mentioned above, gelatinisation is an irreversible process. Further heating of the gelatinised starch grains by conventional techniques does not result in further hydration of the grains. On the contrary, once maximal hydration has been obtained, further heating can lead to degradation of the chemical bonds within the starch grain and loss of properties associated with gelatinisation, such that the volume occupancy of the gelatinised starch will decrease and its viscosity will decrease with further heating. Exposure of the gelatinised starch to shear forces has a similar effect.

As indicated above, there remains a need for further novel starch-based products, and processes for providing such modified starch products. There is also a need for novel starches which provide new functionality suitable for use in a large number of industrial and commercial settings, for example as detailed above.

According to the first aspect of the present invention there is provided a gelatinised starch having an increased volume occupancy achieved by a high degree of hydration during gelatinisation. In one embodiment the gelatinised starch of the present invention has a volume occupancy that is at least 10% (preferably at least 15%, for example is at least 20%) greater than the same starch at the same concentration when fully gelatinised by conventional processes. In the present invention, volume occupancy is determined by measuring the settled volume of the starch. Briefly, volume occupancy can be measured by taking a sample of the starch mixture (for example 50 ml, 100 ml or other convenient volume) and placing the sample into a clean container, which allows visual inspection of its contents (for example a clear plastic or glass pot). The concentration of starch in the sample should be such that the fully hydrated starch component does not completely fill the liquid component (i.e. if necessary the sample should be diluted by a known factor with additional liquid, such as water). The container is preferably sealed to avoid possible contamination of its contents. The container is then allowed to stand at ambient temperature (for example 20° C.) for a period sufficient to allow the solids fraction to settle. Typically a period of 12 hours or greater, for example 24 hours or greater is suitable. Once the solids fraction has settled, the total volume of the contents in the container is measured and also the volume of the settled solids is measured. For a container of constant cross-section, these measurements can most conveniently be carried out by measuring the height of the material meniscus from the container base. Volume occupancy is then calculated as percentage value, namely=(volume of the solids/total volume of container contents)×100. Other methods for determination of volume occupancy are known in the art and include viewing and estimating the size of the individual gelatinised starch grains by microscopy, but this method requires a degree of care and experience to ensure than the starch grains upon which the measurement is taken are undamaged.

The term “gelatinisation by conventional processes” as used herein means the heating of the starch to Tₘₐₓ until no further swelling of the starch grains is obtained. Since the concentration of the starch can affect gelatinisation, the concentration selected for the comparator conventional process should be the same as the concentration used when preparing the hyper-swollen starch of the present invention. Conventional gelatinisation is preferably conducted by heating, possibly with additional stirring, preferably gentle, and may be conveniently achieved by heating the solution of starch-based material and aqueous fluid, for example water, in a waterbath, possibly in an agitated waterbath or with a stirring paddle in the starch solution.

In the present invention, the starch is obtained from any convenient source—natural or artificial—known in the art. For example, in one embodiment, the starch is obtained from sorghum, wheat, rape, sugar cane, maize, rice, potatoes, barley, plantain, tapioca, cassava, rye, mungbeans, peas, sweet potatoes, oats, millet, arrowroot, breadfruits, buckwheat, sago, yam, lentils, kudzu, canna or the like.

In one embodiment, the starch is a native starch. The term “native starch” as used herein refers to a starch in its naturally occurring state and which has not been artificially modified in any way, for example by means of chemical or enzymatic modification or physical modification (e.g. by deliberate and pre-determined exposure to heat or shear forces not normally encountered in nature).

In one embodiment the starch is a modified starch. The term “modified” as used herein means a starch which has been artificially altered or changed in some way. Examples include a chemically modified or enzymatically modified starch. The modification could be by, e.g., removal of crosslinking, insertion of functional groups, partial hydrolysis, or by inserting crosslinks.

In one embodiment the starch is a pregelatinised starch. In this embodiment, “pregelatinised starch” means starch that has been treated (e.g., by heating with water or steam followed by drying or by pressure treatments at ambient or low temperature) to render it more soluble in water.

In one embodiment the starch of the present invention can be used as a substrate for enzymatic modification (for example by α-amylase) or degradation to produce the required end-product.

The present invention is founded on the realisation that gelatinisation of starch under dynamic conditions as described below results in a new form of very highly hydrated gelatinised starch having high volume occupancy.

The very highly hydrated gelatinised starch of the present invention having high volume occupancy is herein referred to as “hyper-swollen”. In the present invention, a “high volume occupancy” means a starch produced according to a process of the present invention that has a volume occupancy of at least 10% greater, preferably greater than 15%, such as, e.g., greater than 20%, than the volume occupancy of the same concentration of the same starch gelatinised by heating in the absence of shear forces to the Tₘₐₓ of that starch for the time required to maximise gelatinsation.

By increasing the volume by which the starch grains swell, there is an increased likelihood that the amylopectin branches on neighbouring gelatinised grains make contact and physically entangle which causes the hyper-swollen starch to exhibit an increased viscosity at concentrations when the starch grains are in point contact with one another.

The dynamic conditions are produced by injection of a high velocity, preferably supersonic, transport fluid and induce conditions which can include a combination of shear, a low pressure region, heat, high velocity (including supersonic) acceleration and deceleration, atomisation to form a vapour-droplet flow regime and a condensation shock. “Atomised” in this context should be understood to mean break down into very small particles or droplets. Such particles or droplets may be of the order of 1 to 5 microns. In some embodiments, depending on the fluid conditions of the mixture being processed, they may be larger or possibly slightly smaller.

Any apparatus capable of providing the dynamic conditions set forth herein may be used in carrying out the processes of the present invention. For example, WO 2006/010949 discloses, inter alia, an apparatus capable of supplying the flow conditions described above and discloses, inter alia, applications whereby the apparatus is used in part of a food production process, a brewing process and a biofuel production process in order to gelatinise starch. And, WO 2008/135775 discloses, inter alia, an apparatus for and process of treating a slurry of starch-based biomass and water by injecting a high velocity transport fluid (such as steam) in such a manner as to improve the starch gelatinisation process. Additional suitable apparatus for applying the required processing conditions to the mixture of starch-based material and working fluid are disclosed, e.g. in WO 2008/135783 and WO 2004/033920. Each of the four above-identified WO publications, which are owned by the present Applicant, are hereby incorporated by reference as if recited in full herein.

In a second aspect of the present invention, there is provided a process for the production of hyper-swollen hydrated gelatinised starch, said process comprising:
combining a starch-containing product with a working fluid to form a mixture; inducing the mixture to flow through an inlet into a passage; and injecting a high velocity transport fluid into the mixture through a nozzle communicating with the passage;
wherein the injection of the high velocity transport fluid:
applies a shear force to the mixture such that the mixture is atomised and forms a vapour and droplet flow regime;
forms an at least partial vacuum within the passage downstream of the nozzle; and
generates a condensation shock wave within the passage downstream of the nozzle and vacuum by condensation of the transport fluid to produce a hyper-swollen hydrated gelatinised starch.

In another aspect of the present invention, there is provided a process for the production of hyper-swollen hydrated gelatinised starch, said process comprising:
inducing a mixture comprising a starch-containing product and a working fluid to flow through an inlet into a passage; and injecting a high velocity transport fluid into the mixture through a nozzle communicating with the passage;
wherein the injection of the high velocity transport fluid:
applies a shear force to the mixture such that the mixture is atomised and forms a vapour and droplet flow regime;
forms an at least partial vacuum within the passage downstream of the nozzle; and

generates a condensation shock wave within the passage downstream of the nozzle and vacuum by condensation of the transport fluid to produce a hyper-swollen hydrated gelatinised starch.

The term “mixture” as used herein refers to any formulation having a starch content greater than 0.25% weight/weight (w/w). The mixture can have, for example, a starch content of from 0.25% w/w up to 40% w/w. The mixture may also contain a number of different starch types.

In one embodiment, other materials can also be included in the mixture to be processed. Exemplary materials include (but are not limited to) chemicals (e.g. biopolymers, synthetic polymers, sugars, salts, acids, metals, oils, pigments, fragrances, flavours, pharmacological compounds), biological components (e.g. enzymes, amino acids, cells, bacteria, viruses) or particulates (e.g. clays and minerals, colloidal metals, natural and man-made fibres). Exemplary enzymes include various amylases, such as α-amylase, β-amylase, and exoamylase; debranching enzymes; and isomerases, including glucose isomerase.

Such additional materials will reflect the intended end use of the hyper-swollen hydrated gelatinised starch. For example, for a cosmetic end use, perfume, colouring etc could be included in the mixture to be processed. For a food application, other ingredients such as vegetables, spices, preservatives etc could be included. However, in applications where a product is being manufactured (for example a food application, production of a cosmetic or a paper), the starch may be processed and then the hyper-swollen starch may be mixed with additional materials and further processed in some manner at a later stage in the manufacturing process. In one non-limiting example, a concentrated mixture of the hyper-swollen starch according to the invention is made and then mixed with the remaining constituent parts of a desired final product in a later processing stage e.g. the concentrated hyper-swollen starch of the invention can be used at different dilutions in various different products, depending on how much each product requires. The hyper-swollen starch of the invention may be used in a secondary process in the formation of an end product. Such subsequent processes may include spray drying, extrusion, baking, spray coating, freeze drying, or a physicho-chemical treatment such as solvent exchange for a non-aqueous solvent.

Non-limiting examples of starch sources include high energy crops such as sorghum, wheat, rape, sugar cane, and maize. Other non-limiting examples include rice, potatoes, barley, plantain, tapioca, cassava, rye, mungbeans, peas, sweet potatoes, oats, millet, arrowroot, breadfruit, buckwheat, sago, yam, lentils, kudzu, canna or the like. Starches may be native (as occurring in nature), or modified (i.e., artificial), for example they can be chemically and/or enzymatically modified (substituted and/or crosslinked) or pre-processed, such as pre-gelatinised or partially gelatinised starches.

In one embodiment the working fluid used to form the mixture is an aqueous fluid, for example water. “Water” in this context is not limited to pure or distilled water, but instead encompasses all types of water (e.g. hard and soft water). The working fluid can be any aqueous solution, water containing soluble and insoluble solids and/or other fluids that are either miscible with or immiscible in water, etc. An exemplary working fluid is a mixture of water and white wine for a food product. Another exemplary working fluid for a food product is milk, or a solution prepared by mixing dried milk powder with water in the desired concentrations for the recipe. A further exemplary working fluid is water mixed with another fluid or solid that is a reagent, included for its chemical properties (such as the ability to break hydrogen-bonds e.g. dimethylsulfoxide (DMSO) or N-methylmorpholine-N-oxide (NMO)). The working fluid can also be any aqueous fluid recovered from another stage in the processing plant or apparatus. An example of such a fluid is process condensate, which is water recovered from a distillation stage. In some applications, such as biofuel or alcohol production, the recovered fluid may be backsef, that is a water-based fluid recovered after a later fermentation stage that may contain dissolved solids, solid debris and other soluble or insoluble impurities. The working fluid for the current process and application may consist of one or several types of aqueous fluid, some examples of which are given above, mixed together.

Preferably, the transport fluid is steam. However, other transport fluids may be used, such as, e.g., a gas such as compressed air, or nitrogen or carbon dioxide or superheated steam or supercritical carbon dioxide.

Preferably, the transport fluid is injected at a supersonic velocity. Although, as noted previously, subsonic velocities may be used so long as the hyper-swollen hydrated gelatinised starch is achieved.

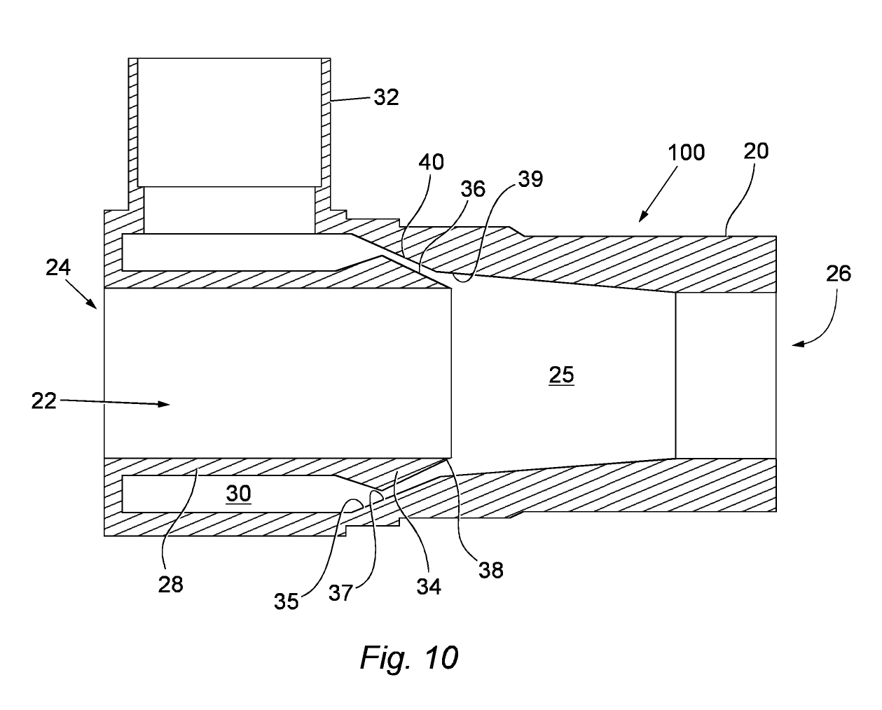

Preferably, the passage is of substantially constant diameter. Preferably the nozzle is an annular nozzle which circumscribes the passage. Preferably, the nozzle has a convergent-divergent flow geometry and is part of an apparatus, e.g., the apparatus of FIG. 10.

The process can be a batch process. Alternatively, the process is an in-line process in which the inlet receives mixture from an upstream portion of a production line, and the passage passes the processed material to a downstream portion of the production line. The process, whether batch or in-line, may include a recirculation loop, whereby the material is returned to the apparatus inlet, or to a point upstream of the apparatus such that it passes through the apparatus several times, or until a particular condition (e.g. material temperature) is reached. Alternatively the process may be a continuous process. The process may contain several apparatus in series, such that the starch-based material passes through a succession of them. In some applications the process may contain several apparatus in parallel, furthermore each parallel leg may contain one apparatus or more than one apparatus in series.

In one embodiment, the temperature of the mixture prior to injection of the transport fluid is below the onset temperature for starch gelatinisation (Tₒ) as measured by differential scanning calorimetry (DSC) or rheological measurement. In one embodiment the mixture is held (steeped) at a temperature below To for a suitable period of time (for example from 15 minutes to 24 hours). This initial steeping allows a small, reversible amount of starch hydration to occur, and can lower the material's glass transition temperature (T_{g}) by a few degrees. In another embodiment the injection of transport fluid into the mixture in order to process the starch based material is continued until the temperature of the mixture has reached or exceeded the gelatinisation peak temperature (Tₚ) of the starch as measured by differential scanning calorimetry. In another embodiment the processing of the mixture by injection of transport fluid is continued until the temperature of the mixture has exceeded the upper thermal limit, also known as the end of gelatinisation range temperature (Tₘₐₓ) of the starch as defined by differential scanning calorimetry, or rheological measurement.

In another embodiment, where the mixture contains more than one type of starch, prior to injection of the transport fluid the temperature of the mixture is below the gelatinisation onset temperature (Tₒ) for the starch with the lowest onset limit. In another embodiment the starting mixture is steeped at a temperature below the Tₒ of the starch with the lowest onset limit for a suitable period of time (for example from 15 minutes to 24 hours). In another embodiment the processing of the mixture by injection of transport fluid is continued until the temperature of the mixture has reached or exceeded the gelatinisation peak temperature Tₚ of the starch with the highest Tₚ as measured by differential scanning calorimetry. In another embodiment the processing of the mixture by injection of transport fluid is continued until the temperature of the mixture has exceeded the upper thermal limit Tₘₐₓ of the starch with the highest upper thermal limit as determined by differential scanning calorimetry.

In another embodiment, where the starting mixture contains more than one type of starch, the initial temperature of the mixture prior to the injection of the transport fluid is selected having regard to the gelatinisation onset temperature (Tₒ) of at least one of the starches in the mixture. This starch may or may not be the starch with the lowest Tₒ value in the mixture, but this approach facilitates differentiated gelatinisation characteristics in the starch. In another embodiment the starting mixture is steeped at a temperature below the Tₒ of at least one of the starches in the mixture for a suitable period of time (for example from 15 minutes to 24 hours). In another embodiment the processing of the mixture by injection of transport fluid is continued until the temperature of the mixture has reached or exceeded the gelatinisation peak temperature Tₚ of at least one of the starches in the mixture, as measured by differential scanning calorimetry. In another embodiment the processing of the mixture by injection of transport fluid is continued until the temperature of the mixture has exceeded the temperature Tₘₐₓ (which marks the end of the temperature range at which gelatinisation occurs) for at least one of the starches, as determined by differential scanning calorimetry.

Generally it will be convenient to determine the Tₒ, Tₚ and Tₘₐₓ temperatures for at least one starch in the starting mixture prior to performing the process of the invention. Measurement of these values by conventional techniques such as DSC is routine within the art. Differential Scanning Calorimetry (DSC) means the measurement of the change of the difference in the heat flow rate to the sample and to a reference sample while they are subjected to a controlled temperature program. During events such as gelatinisation, which is said to be endothermic, energy is required by the starch as it irreversibly swells. The additional energy required by the sample relative to the reference sample appears as a peak on the baseline when the two energy inputs are plotted together. Alternatively the difference between the energy requirements can be calculated and optionally plotted. Tₒ is the calculated point at which the deviation from the baseline begins, Tₘₐₓ where the deviation ends, and Tₚ the point of greatest deviation. The process of gelatinisation is said to be endothermic, and occurs over different temperature ranges for different types of starch and starch-containing materials. Typically gelatinisation occurs between about 50° C. and 75° C. There are various types of DSC machines. In one type of DSC machine a starch-containing material in an aqueous solution at the appropriate concentration (% w/w) and the machine's reference material or a reference sample of the aqueous solution used to make the slurry with the starch-containing material are heated from room temperature to approximately 85° C. at a controlled rate. In the temperature range where gelatinisation occurs, the aqueous solution of starch-containing material will require a greater energy input than the reference sample in order to maintain the same rate of temperature increase. This difference in energy requirement is measured. From the graph so produced, the gelatinisation onset temperature (Tₒ), end of gelatinisation range (Tₘₐₓ) and point of greatest energy requirement (Tₚ) (i.e. gelatinisation peak temperature) of the gelatinisation process can be determined. The temperature profile will be measured for the concentration of starch to be used in the starting mixture (since the starch concentration will affect the Tₒ, Tₚ and Tₘₐₓ values).

In one embodiment, the process of the invention is commenced at a temperature of Tₒ−10° C. or above, wherein the Tₒ value is as determined for the concentration of at least one starch in the starting mixture. Optionally the process of the invention is commenced at a temperature of Tₒ−8° C. or above, for example at a temperature of Tₒ−5° C. or above.

In one embodiment the process of the invention is continued until the Tₘₐₓ temperature is achieved or exceeded, wherein the Tₘₐₓ value is as determined for the concentration of at least one starch in the starting mixture (optionally the same starch used for establishing the Tₒ value).

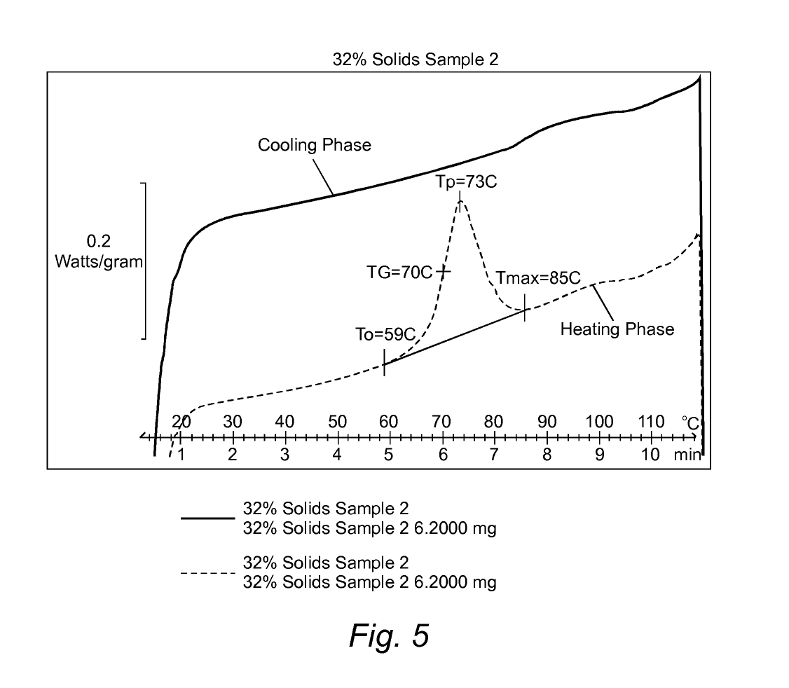

FIG. 5 shows an exemplary DSC profile for standard (conventional) gelatinisation of maize grounds at 32% solids. Tₒ is 59° C., Tₚ is 73° C. and Tₘₐₓ is 85° C. The glass transition temperature T_{g} is 70° C.

In one embodiment, where more than one apparatus is in series, all of the apparatuses are operated at the same pressure, mass flow rate and temperature conditions. In another embodiment, all of the fluid reactors are controlled separately and the operating conditions of pressure, mass flow rate and temperature conditions are independently selected for each apparatus. In one preferred embodiment three or more fluid apparatuses in series are operated so as to supply energy to the starch-based material in a manner based on the shape of the peak in the DSC curve. This could be achieved by, for instance determining the temperature at the inlet and the exit of each apparatus and adjusting the transport fluid inlet supply pressure until the temperature rise across each apparatus is such that the energy supplied to the apparatus matches the requirements of the DSC curve. Where one or more type of starch is present in the mixture, the operating conditions for each apparatus in the series could be controlled so as to supply more or less energy to each depending on the temperature of the mixture as it enters each individual apparatus (for example, measured using a temperature measuring device such as a thermocouple at or upstream of the apparatus inlet) and the critical temperatures as determined from the DSC profiles for the or each starch present in the mixture. Where at least one apparatus is operating with a recirculation loop, the operating conditions of the transport fluid to that apparatus could be varied over time (for example, a controller could be linked to a temperature measuring device at the apparatus inlet so as to determine the temperature of the mixture and adjust the transport fluid operating conditions accordingly) so as to inject more or less energy into the starch-based material over time.

The present invention will now be further described by reference to the following, non-limiting, examples and figures in which:

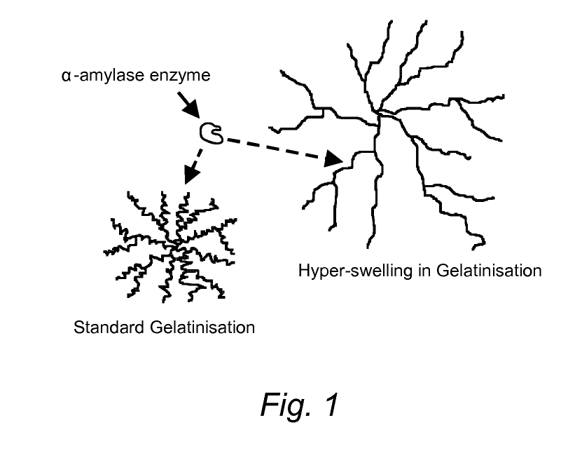

FIG. 1 is a schematic representation showing starch gelatinised according to prior art methodologies (“Standard Gelatinisation”) compared to the highly hydrated starch according to the present invention (“Hyper-swelling in Gelatinisation”);

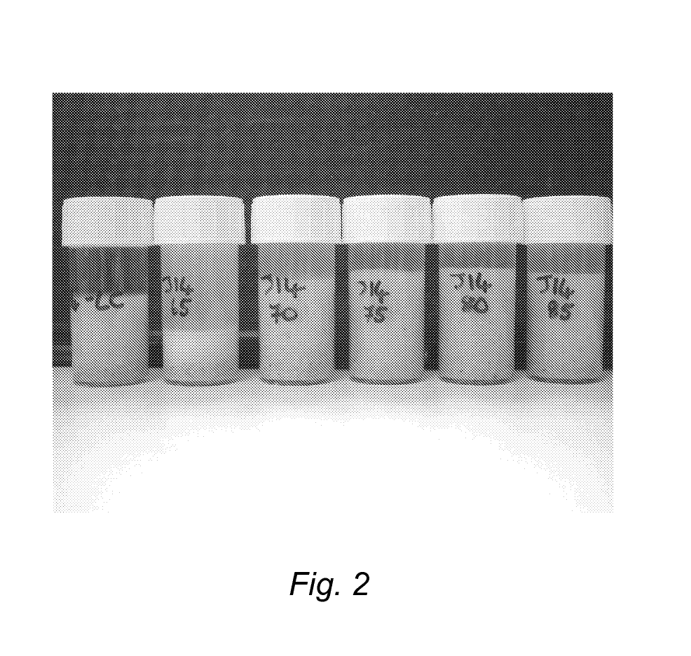

FIG. 2 shows settled volumes for 10% w/w ground maize slurry as sampled from the control (LC) and slurry processed according to the invention taken at 65° C., 70° C., 75° C., 80° C. and 85° C.;

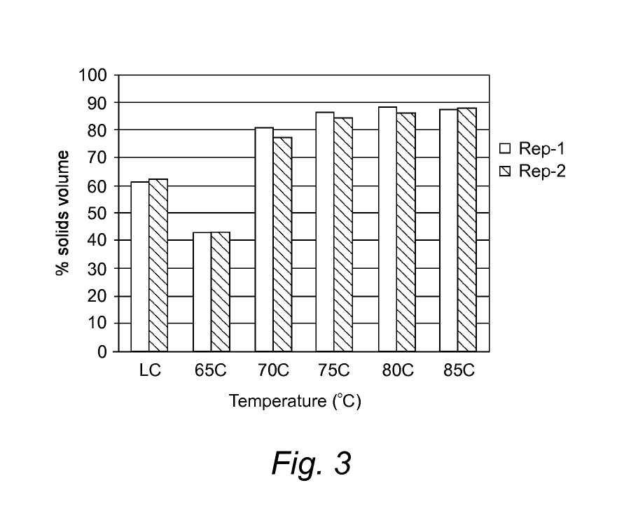

FIG. 3 is a bar graph presenting percentage settled volumes for replica experiments for 10% w/w ground maize slurry samples: passively heated and activated control (LC) and samples treated according to the invention taken at 65° C., 70° C., 75° C., 80° C. and 85° C.;

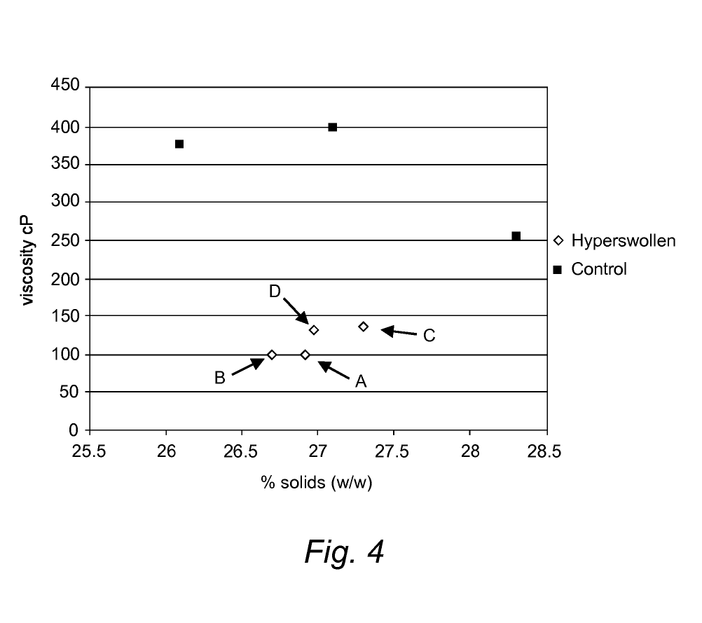

FIG. 4 shows viscosity at 20° C. vs. solids content for maize slurries gelatinised with control (standard) and hyper-swollen starch according to the invention after incubation at 85° C. with α-amylase for 120 minutes.

FIG. 5 shows an exemplary DSC endotherm profile for maize grounds at 32% solids (w/w).

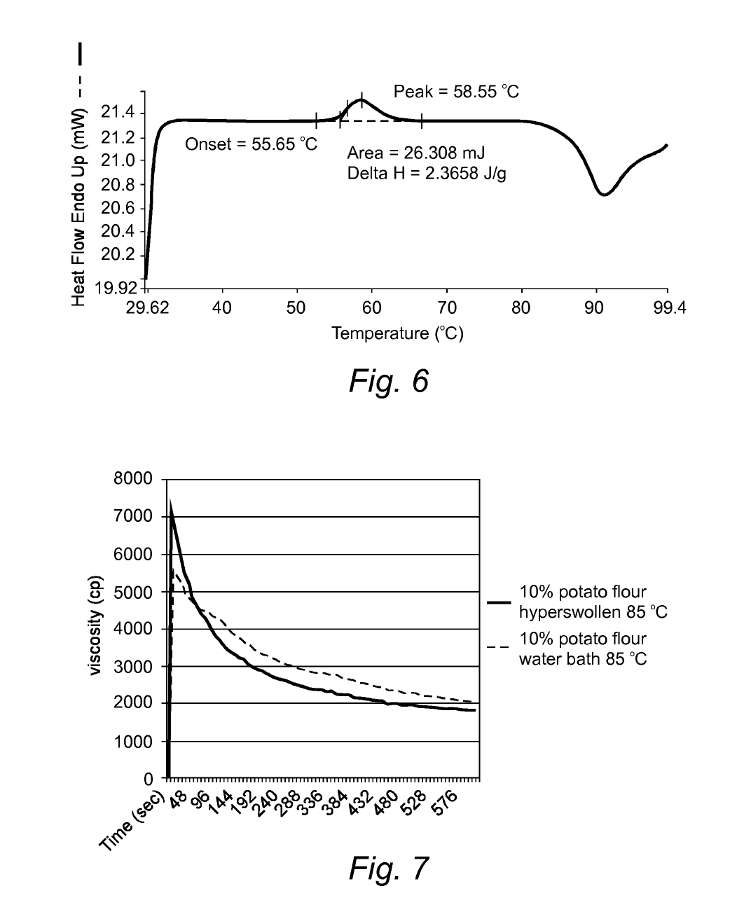

FIG. 6 shows an exemplary DSC endothermic profile for potato flour at 10% solids (w/w).

FIG. 7 shows the RVA pasting viscosity curves for hyper-swollen and control potato flour (10% w/w solids) at 85° C.

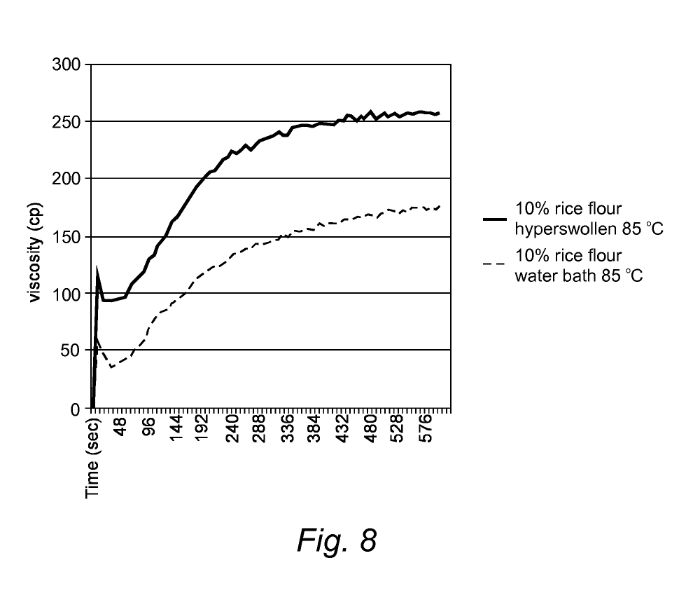

FIG. 8 shows the RVA pasting viscosity curves for hyper-swollen and control corn flour (10% w/w solids) at 85° C.

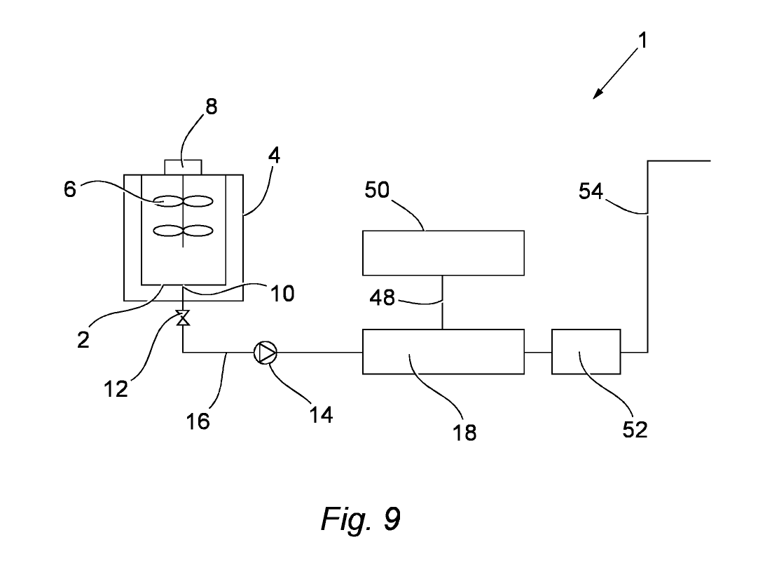

FIG. 9 is a schematic view of a system including an apparatus able to perform the process according to the present invention.

FIG. 10 shows a longitudinal section through the representative apparatus of FIG. 9.

With reference to FIG. 10, the apparatus 100 comprises a housing 20 that defines a passage 22. The passage 22 has an inlet 24 and an outlet 26, and is of substantially constant diameter. The inlet 24 is formed at the front end of a protrusion 28 extending into the housing 20 and defining exteriorly thereof a plenum 30. The plenum 30 has a transport fluid inlet 32. The protrusion 28 defines internally thereof part of the passage 22. The distal end 34 of the protrusion 28 remote from the inlet 24 is tapered on its relatively outer surface at 36 and defines a transport fluid nozzle 38 between it and a correspondingly tapered part 40 of the inner wall of the housing 20. The nozzle 38 is in fluid communication with the plenum 30 and is preferably annular such that it circumscribes the passage 22. The nozzle 38 has a nozzle inlet 35, a nozzle outlet 39 and a throat portion 37 intermediate the nozzle inlet 35 and nozzle outlet 39. The nozzle 38 has convergent-divergent internal geometry, wherein the throat portion 37 has a cross sectional area which is less than the cross sectional area of either the nozzle inlet 35 or the nozzle outlet 39. The nozzle outlet 39 opens into a mixing chamber 25 defined within the passage 22.

FIG. 9 schematically illustrates a system which processes starch-containing material, thus producing hyper-swollen hydrated gelatinised starch. The system, generally designated 1, comprises an optional first vessel 2 acting as a first hydrating means. The first vessel 2 has a heating means, which is preferably a heated water jacket 4 which surrounds the vessel 2 and receives heated water from a heated water supply (not shown). The vessel 2 also includes an agitator 6 that is powered by a motor 8. The agitator 6 is suspended from the motor 8 so that it lies inside the vessel 2. At the base of the vessel 2 are an outlet 10 and a valve means 12 which controls fluid flow from the outlet 10. Downstream of the first vessel 2 is a first supply line 16, the upstream end of which fluidly connects to the outlet 10 and valve means 12 whilst the downstream end of the supply line 16 fluidly connects with a reactor 18. A low shear pump 14 optionally may be provided in the supply line 16. The pump 14 may be a centrifugal pump which has been modified in order to reduce shear as fluid is pumped through it.

The reactor 18 is formed from one or more apparatuses 100 as described in WO 2004/033920 and WO 2008/135775. An exemplary apparatus 100 for use in the process according to the present invention is shown in detail in FIG. 10.

Referring once again to FIG. 9, the reactor 18 is connected to a transport fluid supply 50 via a transport fluid supply line 48. With reference to FIGS. 9 and 10, the transport fluid inlet 32 of the or each apparatus 100 making up the reactor 18 is fluidly connected with the transport fluid supply line 48 for the receipt of transport fluid from the transport fluid supply 50.

Located downstream of the reactor 18 and fluidly connected thereto is an optional temperature conditioning unit (TCU) 52. The TCU 52 preferably comprises an apparatus substantially identical to that illustrated in FIG. 10, and will therefore not be described again in detail here. The TCU 52 can either be connected to the transport fluid supply 50 or else it may have its own dedicated transport fluid supply (not shown).

Downstream of the TCU 52 is a second supply line 54, which fluidly connects the outlet of the TCU 52 either with a storage vessel (not shown) or with a further reactor 18 (not shown). If the processed mixture is placed into a storage vessel this may optionally be heated by means of a heated water jacket which surrounds the storage vessel and receives heated water from a heated water supply (not shown) analogously to jacket 4 on vessel 2. The storage vessel can optionally also include an agitator that is powered by a motor again analogously to that provided for vessel 2. The storage vessel will have an outlet and a valve means to control fluid flow from the outlet. If the processed mixture is passed into a further reactor 18, it will be further subjected to injection of the transport fluid.

A method of processing hydrated starch using the apparatus 100 illustrated in FIGS. 9 and 10 will now be described in detail. Firstly, a ground starch-containing feedstock is introduced into the first vessel 2 at a controlled mass addition flow rate. Examples of suitable feedstock include dry milled maize, wheat or sorghum. The starch-containing feedstock is mixed with a working fluid, preferably water, and that working fluid is then added to the feedstock in the vessel 2 to form a mixture and to start to hydrate the feedstock. Preferably, the ratio of feedstock to liquid content in the slurry is 20-40% by weight. Optionally, one or more pH adjusters and/or a surfactant can also be added to the mixture at this point.

Heated water is fed into the water jacket 4 surrounding the vessel 2 and the heated water jacket then heats the mixture to a temperature below the onset temperature for starch gelatinisation (Tₒ) and holds the mixture at this temperature for 30-120 minutes. The motor 8 drives the agitator 6, which stirs the mixture in the vessel 2 with gentle (i.e. low shear) agitation whilst the mixture is held in the vessel 2.

The mixture is held at the desired temperature in the vessel 2 for a sufficient period of time to allow a small reversible amount of starch hydration to occur, so that the starch content to be prepared for full hydration. When the mixture has been steeped in the vessel 2 for sufficient time, the valve 12 is opened to allow the mixture to leave the vessel via the outlet 10. The pump 14 pumps the mixture under low shear conditions from the vessel 2 through the first supply line 16 to the reactor 18.

Referring again to FIG. 10, when the mixture reaches the or each apparatus 100 forming the reactor 18, the mixture will pass into the apparatus 100 through inlet 24 and out of the outlet 26. Transport fluid, which in this non-limiting example is preferably steam, is fed from the transport fluid supply 50 at a preferred pressure of between 5-7 Bar to the, or each, transport fluid inlet 32 via transport fluid supply line 48. Introduction of the transport fluid through the inlet 32 and plenum 30 causes a jet of steam to issue forth through the nozzle 38 at a very high, preferably supersonic, velocity. As the steam is injected into the mixture, a momentum and mass transfer occurs between the two which preferably results in the atomisation of the working fluid component of the mixture to form a dispersed droplet flow regime. This transfer is enhanced through turbulence. The steam preferably applies a shearing force to the mixture which not only atomises the working fluid component but also disrupts the cellular structure of the feedstock suspended in the mixture, such that the starch granules present are separated from the feedstock.

### EXAMPLE 1

### Hyper-Swelling

Native starch in the form of ground maize at a solids loading of 10% w/w was steeped (incubated) with a working fluid of water at a temperature of 52° C. for 30 minutes in a vessel. The mixture so formed had a Tₒ of 58° C. as measured by DSC and was then activated (gelatinised) by passing through an apparatus (see FIG. 10) with a 25 mm bore connected in a recirculation configuration as disclosed, e.g., in WO 2008/135775. This test rig consisted of pipework connecting the vessel exit to an apparatus and from the apparatus exit back to the vessel inlet. Opening the vessel exit and starting the injection of transport fluid (in this case steam) into the apparatus caused the maize mixture to start circulating around the test rig (in cases with a higher solids loading, the pumping action of the apparatus can be supplemented with a pump between it and the vessel). The transport fluid (in this case steam) was injected into the mixture in order to impart a combination of shear, thermal, pressure and kinetic forces. A pressure measuring device in the flow passage of the reactor approximately 5 cm (two inches) downstream of the nozzle injecting the transport fluid provided a visual pressure read-out. The operator used this pressure reading to manually adjust the pressure of the steam at the transport fluid inlet, with the aim of maintaining the lowest possible measured pressure in the flow passage. This continuous adjustment was necessary because the viscosity of the maize mixture varied over time as it recirculated through the apparatus and was gelatinised.

As the maize slurry was re-circulated through the test rig, samples of material were taken at specific temperature intervals covering the gelatinisation temperature range for the maize as measured by differential scanning calorimetry (DSC). A temperature measuring device measured the temperature of the maize mixture as it exited the pipework and entered the vessel and the sample was taken at 5° C. intervals from the mixture exiting the pipework at this point. A control sample was prepared by placing 10% w/w ground maize slurry in a sealed glass jar and passively heating by standing in a controlled waterbath at 85° C. to activate the starch.

Each of the samples acquired from the experimental process and the control material were sub-sampled into 100m1 clear plastic sample pots. The pots were allowed to stand at 20° C. for 24 hours to settle the solids fraction. Settled volumes were then calculated for the gelatinised maize slurries as the percentage of the total material column occupied by solids (measured heights).

FIG. 2 shows the settled volumes of gelatinised maize slurry for the control material (LC) and samples taken at 65°-85° C. For all of the treated samples at temperatures above 70° C., where a majority of the starch is gelatinised there is a visible increase in the height of the settled volume of solids over the control. FIG. 3 is a graph of the absolute % volume occupancy of the settled solids from replica experimental runs. Again the volume increase of 15-20% is seen in this case. This observed volume increase was seen to be stable over time at 20° C. and in refrigeration at 5° C. for one week.

### EXAMPLE 2

### Hyper-Swollen Starch as a Modified Enzyme Substrate

Control and hyper-swollen starch-based materials were prepared in the following manner in order to provide final materials with dry solids contents of around 27% w/w.

Control: Ground yellow dent maize (corn) was added weight for weight to 40° C. water in an agitated water jacketed vessel at a ratio achieving 27% solids. The vessel jacket temperature was raised in order to achieve a product temperature of 85° C., and then held at this temperature for 30 minutes to ensure gelatinisation and hydration of the starch.

Hyper-swollen Starch: Ground yellow dent maize (corn) was added to 40° C. water in an agitated water jacketed vessel in a weight ratio to achieve an initial solids concentration of 32% w/w. This was the calculated concentration required to give a final mixture after processing with dry solids around 27% w/w. The calculation took into account addition of water from the steam used as the transport fluid during processing. The maize slurry was soaked in the vessel for 30 minutes at 50° C. and then processed via four apparatuses of the type disclosed, inter alia, in WO 2008/135775 and shown, e.g., in FIG. 10, arranged in series. The operating conditions of the apparatuses in four different runs (Cases A to D) are given in Table 1 below. Cases A and B were run at a lower volumetric flow rate, and Cases C and D at a higher volumetric flow rate. Two different transport fluid (steam) injection regimes were used to process the maize mixture. In the first regime all four (or three in Case B where the volumetric flow rate was slower) of the apparatuses operated with the same steam inlet pressure (i.e. using a ‘flat’ profile). In the second regime (Cases A and C) an ‘endothermic’ profile was used. This used the DSC endotherm trace for the material to determine the temperature range that correlated with the maximum energy requirement for the gelatinisation process as indicated by the peak in the curve between Tₒ and Tₘₐₓ. The apparatuses were then adjusted so that the maximum possible energy was injected into the mixture over the temperature range that correlated with the peak. This was achieved by manually adjusting the steam inlet pressure for each apparatus in turn from 1 to 4 until the desired change in mixture temperature across each apparatus was achieved. In all cases the gelatinised starch-based material exited the last apparatus (Apparatus 4) at a temperature of approximately 85° C.

TABLE 1

| | Case A | Case B | Case C | Case D |
|---|---|---|---|---|
| Dry solid (w/w %) | 26.91 | 26.69 | 27.29 | 26.97 |
| Viscosity (cP) | 100 | 100 | 136 | 132 |
| Maize mixture | 80 | 80 | 107 | 107 |
| volumetric flow rate | | | | |
| (l/min) | | | | |
| Steam profile | endotherm | flat | endotherm | flat |
| Inlet temp (° C.) | 50 | 50 | 52 | 52 |
| After Apparatus 1 (° C.) | 57 | 50 | 60 | 61 |
| After Apparatus 2 (° C.) | 68 | 62 | 69 | 69 |
| After Apparatus 3 (° C.) | 80 | 72 | 77 | 77 |
| After Apparatus 4 (° C.) | 85 | 84 | 85 | 85 |
| Steam pressure | | | | |
| (bar gauge) | | | | |
| Apparatus 1 | 3.7 | / | 6.2 | 6.9 |
| Apparatus 2 | 7.4 | 6.6 | 7.3 | 6.9 |
| Apparatus 3 | 7.6 | 6.8 | 7.5 | 6.7 |
| Apparatus 4 | 2.9 | 6.7 | 6.6 | 6.2 |

For both control and hyper-swollen starch treatments commercial α-amylase enzyme was added to the starting mixture at a dose rate of 0.2 Kg per metric tonne of maize (corn).

Gelatinised (activated) sample material from both the Control and Hyper-swollen treatments were incubated in sealed agitated vessels at 85° C. for 120 minutes to facilitate liquefaction of the mixture by action of the α-amylase. Absolute solids for each individual sample were measured by loss on drying whereby samples were placed in an oven at 105° C. for three hours.

At the end of the incubation time the enzyme-treated starch-based materials were cooled to 20° C. and their final viscosities were measured using a Brookfield DV-II+Pro Viscometer.

FIG. 4 shows a graph of the final viscosities of the resultant starch-based materials after the 120 minute α-amylase incubation as a function of solids content. The control material finishes with much higher viscosities than the hyper-swollen material indicating that the control product has a molecular weight profile containing degradation products with higher molecular weights than the hyper-swollen starch samples. This indicates that the α-amylase has produced different molecular weight profiles for the two different treatments of starch gelatinisation. Measurements of enzyme activity via a reducing sugar assay (dextrose equivalence, DE) shows all of the samples to have experienced a similar level of hydrolysis, therefore the differences in the molecular weight profiles are due to the enzyme's ability to penetrate into and act upon the amylopectin substrate. This mechanism is shown in FIG. 1.

### EXAMPLE 3

Control and hyper-swollen starch-based materials as listed in Table 2 were prepared and tested in the following manner.

Control: A control was prepared by mixing 15° C. tap water with a test material at a w/w % ratio as given in Table 2. The control was then placed in a sealed glass jar and passively heated by standing it in a controlled waterbath at 85° C. with mild agitation for 20 minutes to ensure gelatinisation and hydration of the starch in the material. Material temperature was monitored to ensure core temperatures of 85° C. for at least 5 minutes. The Loss on Drying (LOD) technique was used to determine the proportions of water and dry matter in the control. LOD involves weighing a small portion (approx 5 g) of the control into a pre-weighed dry dish and placing the dish into an oven at 105° C. for 3 hours. The dish and sample are then left to cool in a dessicator, and then weighed once more. The wet and dry proportions of the control can then be determined.

Hyper-swollen Starch: A starch-containing material, as listed in Table 2, was added to water in the required mass ratios to provide the desired % w/w concentrations of the starch-containing material. The concentrations are listed in Table 2. 60 Kg batches of the slurries were made for each process experiment. Dilution of material by steam condensate was accounted for in the batching of the slurries to give the correct mass ratios at the end of process. Material solids were also checked via the LOD technique described above.

Once the slurry had been soaked it was then processed via one of the apparatuses according to FIG. 10 as described above (hereafter referred to as the apparatus). As shown in FIG. 9, this involved passing all the material in the storage vessel 2 through the apparatus 100 to a collection tank (not shown in FIG. 9). Once the storage vessel 2 had been emptied and as much material as possible collected in the collection tank, the contents of the collection tank were returned to vessel 2 and processed through the apparatus 100 of reactor 18 once more. This was repeated until the temperature of the material, as measured downstream of the apparatus 100, reached approximately 85° C. (approximately 5 passes from a starting temperature of approximately 15° C.).

Samples of the processed material were taken at the end of processing for all materials. LOD was performed for small samples of the final processed material in all cases to check for correct final solids concentrations. A DSC curve was measured for Materials A to G, by heating the correct concentration of starch-containing material in deionised water at a heating rate of 2° C./minute to a final temperature of 95° C. All samples were tested for peak viscosity and pasting viscosity using a Rapid Visco Alalyser (RVA), Newport Scientific, at a shear rate of 160 rpm. Rheological measurements were made at 85° C. to inhibit viscosity build in the samples due to retrogradation of free amylose of the starch based materials (re-association of amylose molecules to form a cross-linked structure).

TABLE 2

| | Biological | Natural/ | | Slurry |
|---|---|---|---|---|
| Material | Origin | Modified | Supplier/Product Name | (w/w %) |
| A | Maize | Modified | Tate & Lyle/Resistamyl ™ | 5 |
| | | | 348 | |
| B | Wheat | Natural | Mix ‘n’ Bake/Plain Flour | 10 |
| C | Maize | Natural | National Starch/ | 5 |
| | | | Novation ® 2300 | |
| D | Rice | Natural | Dove's Farm/Stoneground | 10 |
| | | | Rice Flour | |
| E | Potato | Natural | Farina/Potato Flour | 10 |
| F | Maize | Natural | Dr Oetker/Corn flour | 10 |
| G | Maize and | Modified | Mixture of Sample A and | 2.5% of |
| | Potato | and | Sample E | each |
| | | Natural | | |
| H | Semolina | Natural | Whitworth's | 10% |
| I | Porridge | Natural | Chef's Larder Rolled Oats | 10% |
| | Oats | | | |

Results:

For all materials listed in Table 2 DSC endothermic profiles were obtained to identify the gelatinisation temperature ranges for each material. An exemplary DSC profile for 10% potato flour is shown in FIG. 6. Table 3 details the endotherm data obtained from these measurements.

TABLE 3

| | Biological | | | |
|---|---|---|---|---|
| Material | Origin | Tₒ (° C.) | Tₚ (° C.) | Tₘₐₓ (° C.) |
| A | Maize | 55.79 | 62.99 | 70.01 |
| B | Wheat | 51.57 | 58.04 | 66.10 |
| C | Maize | 56.49 | 63.04 | 71.04 |
| D | Rice | 56.23 | 61.77 | 70.2 |
| E | Potato | 52.65 | 58.55 | 67.02 |
| F | Maize | 57.79 | 66.14 | 72.12 |
| G | Maize and | 51.76 | 62.88 | 73.23 |
| | Potato | | | |
| H | Semolina | 53.62 | 61.66 | 67.48 |
| I | Porridge | * | * | * |
| | Oats | | | |

* Too large for DSC

From the Tₘₐₓ values obtained for all materials it can be seen that the final cook temperature for both control and hyper-swollen materials (80-85° C.) are in excess of the end of the gelatinisation event by at least 6° C. Therefore observed differences in the materials are not due to partial or incomplete gelatinisation of the starches.

FIGS. 7 & 8 act as example behaviours observed for the pasting viscosities of systems with no or little protein present in the material (potato flour) and that with a natural protein component (corn flour). The potato flour (having little or no inherent protein) shows a classic pasting decay of viscosity consistent with shear degradation of the swollen starch structure. In this case the hyper-swollen material exhibits a much faster decrease in viscosity over time compared to the control. This behaviour is indicative of the relatively high volume occupancy and low density of the hydrated starch making it more vulnerable to shear damage. In the corn flour example (FIG. 8) the materials can be seen to undergo an initial shear degradation, with the hyper-swollen sample having a faster rate of viscosity decay. However, viscosity build is subsequently observed for both materials due to starch protein interactions.

For all starch based materials in this study the initial peak viscosities (at the start of rheological measurement) for the hyper-swollen materials were always higher than their corresponding control materials. This was consistent with the physical properties of the starch in the hyper-swollen state with high volume occupancy and increased polymer entanglement. The materials tested in this example reflect very different particle sizes from the rolled oats at the mm scale to refined starches typically in the size range of 50 μm. The peak viscosity values are detailed in Table 4.

TABLE 4

| | | Peak viscosity | Peak viscosity |
|---|---|---|---|
| Material | Biological origin | Hyper-swollen (cp) | Control (cp) |
| A | Maize | 501 | 238 |
| B | Wheat | 418 | 372 |
| C | Maize | 146 | 70 |
| D | Rice | 109 | 58 |
| E | Potato | 6824 | 5217 |
| F | Maize | 1433 | 806 |
| G | Maize and Potato | 3226 | 2145 |
| H | Semolina | 98 | 83 |
| I | Porridge Oats | 235 | 179 |

Although the present invention has been described primarily with reference to starch, it is contemplated that the scope of the invention includes the preparation of polyolefins, other cross-linked polymer systems e.g., carbomers, and other similar polysaccharides and other equivalent agents with improved and/or novel characteristics useful in, e.g., the food and plastics industries. Non-limiting examples of polysaccharides that may be prepared according to the methods of the present invention include guar and locust bean gums, Carageenans, agars, gum Arabic, gum tragacanth, pectins, alginates, xanthan gum, carboxymethyl-cellulose, methyl cellulose, other similar celluloses, other similar modified starches.

1. A process for the production of hyper-swollen hydrated gelatinised starch, said process comprising:
combining a starch-containing product with a working fluid to form a mixture;
inducing the mixture to flow through an inlet into a passage; and injecting a high velocity transport fluid into the mixture through a nozzle communicating with the passage;
wherein the injection of the high velocity transport fluid:
applies a shear force to the mixture such that the mixture is atomised and forms a vapour and droplet flow regime;
forms an at least partial vacuum within the passage downstream of the nozzle; and
generates a condensation shock wave within the passage downstream of the nozzle and vacuum by condensation of the transport fluid to produce a hyper-swollen hydrated gelatinised starch.

2. The process as claimed in claim 1 wherein the working fluid is an aqueous fluid.

3. The process as claimed in claim 1 wherein said transport fluid is steam.

4. The process as claimed in claim 1 wherein said transport fluid is injected at a supersonic velocity.

5. The process as claimed in claim 1 wherein the temperature of the mixture prior to injection of the transport fluid is at least 10° C. lower than the Tₒ temperature of at least one starch in the mixture.

6. The process as claimed in claim 1 wherein the processing of the mixture by injection of the transport fluid continues until the mixture reaches the gelatinisation peak temperature (Tₚ) of at least one of starch in the mixture.

7. The process as claimed in claim 1 wherein the temperature of the mixture does not exceed the Tₘₐₓ of at least one of starch in the mixture.

8. The process as claimed in claim 1 wherein said starch-containing product comprises native starch.

9. The process as claimed in claim 1 wherein said starch-containing product comprises pre-gelatinised starch.

10. The process as claimed in claim 1 wherein said starch-containing product comprises starch selected from the group consisting of from sorghum, wheat, rape, sugar cane, maize, rice, potatoes, barley, plantain, tapioca, cassava, rye, mungbeans, peas, sweet potatoes, oats, millet, arrowroot, breadfruit, buckwheat, sago, yams, lentils, kudzu, canna and combinations thereof.

11. The process as claimed in claim 1 wherein the mixture has a starch content of greater than 0.25% w/w.

12. The process as claimed in claim 11 wherein the mixture has a starch content of from 0.25% to 40% w/w.

13. The process as claimed in claim 1 wherein two or more different starch types are present in the mixture.

14. The process as claimed in claim 1 wherein the process is operated as a batch process.

15. The process as claimed in claim 1 wherein the process is operated as a continuous process.

16. The process as claimed in claim 1 wherein the hyper-swollen hydrated gelatinised starch produced has a volume occupancy at least 10% greater than the volume occupancy of the same concentration of the same starch gelatinised by heating in the absence of shear forces to the Tₚ of that starch for the time required to maximise gelatinsation.

17. The process as claimed in claim 1 wherein the hyper-swollen hydrated gelatinised starch produced has a volume occupancy at least 15% greater than the volume occupancy of the same concentration of the same starch gelatinised by heating in the absence of shear forces to the Tₚ of that starch for the time required to maximise gelatinsation.

18. The process as claimed in claim 16 wherein the volume occupancy of the hyper-swollen hydrated gelatinised starch is measured by differential scanning calorimetry.

19. The process as claimed in claim 16 wherein the 10% or greater volume occupancy of the hyper-swollen hydrated gelatinised starch is by comparison to the same concentration of the same starch when gelatinised by heating in a waterbath to the Tₚ of that starch in the absence of shear forces for the time required to maximise gelatinsation.

20. A hyper-swollen hydrated gelatinised starch obtained by the process as claimed in claim 1.

21. A starch gelatinised to have a volume occupancy at least 10% greater than the volume occupancy of the same concentration of the same starch when gelatinised by heating in the absence of shear forces to the Tₚ of that starch for the time required to maximise gelatinsation.

22. The starch as claimed in claim 21 wherein said volume occupancy is at least 15% greater than the volume occupancy than the same concentration of the same starch when gelatinised by heating in the absence of shear forces to the Tₚ of that starch for the time required to maximise gelatinsation.

23. The starch as claimed in claim 21 wherein said volume occupancy is measured by differential scanning calorimetry.

24. The starch as claimed in claim 21 wherein the volume occupancy is at least 10% greater than the volume occupancy of the same concentration of the same starch when gelatinised by heating in a waterbath in the absence of shear forces to the Tₚ of that starch for the time required to maximise gelatinsation.

25. The starch as claimed in claim 21 which is a starch selected from the group consisting of sorghum, wheat, rape, sugar cane, maize, rice, potatoes, barley, plantain, tapioca, cassava, rye, mungbeans, peas, sweet potatoes, oats, millet, arrowroot, breadfruit, buckwheat, sago, yams, lentils, kudzu, of canna and combinations thereof.

26. A process for the production of hyper-swollen hydrated gelatinised starch, said process comprising:
(a) inducing a mixture comprising a starch-containing product with a working fluid to flow through an inlet into a passage; and
(b) injecting a high velocity transport fluid into the mixture through a nozzle communicating with the passage;
wherein the injection of the high velocity transport fluid:
(i) applies a shear force to the mixture such that the mixture is atomised and forms a vapour and droplet flow regime;
(ii) forms an at least partial vacuum within the passage downstream of the nozzle; and
(iii) generates a condensation shock wave within the passage downstream of the nozzle and vacuum by condensation of the transport fluid to produce a hyper-swollen hydrated gelatinised starch.
